(19) United States
(12) Patent Application Publication
(10) Pub. No.: US 2015/0103271 A1
(43) Pub. Date: Apr. 16, 2015

(54) TOUCH SENSOR

(71) Applicant: SAMSUNG ELECTRO-MECHANICS CO., LTD., Suwon-Si (KR)

(72) Inventors: Tae Kyung LEE, Suwon-Si (KR); Man Sub Shin, Suwon-Si (KR); Beom Seok Oh, Suwon-Si (KR); Kee Su Jeon, Suwon-Si (KR); Deok Seok Oh, Suwon-Si (KR); Ho Joo Lee, Suwon-Si (KR)

(73) Assignee: SAMSUNG ELECTRO-MECHANICS CO., LTD., Suwon-Si (KR)

(21) Appl. No.: 14/499,179

(22) Filed: Sep. 28, 2014

(30) Foreign Application Priority Data
Oct. 10, 2013 (KR) 10-2013-0120776

(51) Int. Cl. G06F 3/044; G06F 3/041

(52) U.S. Cl. CPC G06F 3/044; G06F 3/0412
USPC 349/12; 428/192; 324/658

(57) ABSTRACT

Disclosed herein is provided with a touch sensor, including: a window substrate; a first bezel layer formed at an edge portion of the window substrate and formed of at least one layer; and a resin layer disposed on the first bezel layer and the window substrate. The touch sensor further includes a second bezel layer disposed on the resin layer, at a position corresponding to the first bezel layer and the resin layer is made of a transparent material having a refractive index lower than that of the first bezel layer and the second bezel layer. As described above, the plurality of bezel layers and the resin layer are stacked together to form a difference in refractive index, thereby implementing a clear color even by the thinner bezel layer.

### CROSS REFERENCE TO RELATED APPLICATION

This application claims the benefit of Korean Patent Application No. 10-2013-0120776, filed on Oct. 10, 2013, entitled “Touch Sensor”, which is hereby incorporated by reference in its entirety into this application.

### BACKGROUND OF THE INVENTION

1. Technical Field

The present invention relates to a touch sensor.

2. Description of the Related Art

With the development of computers using a digital technology, computer-aided devices have also been developed, and personal computers, portable transmitters and other personal information processors execute processing of texts and graphics using a variety of input devices such as a keyboard and a mouse.

With the rapid advancement of an information-oriented society, the use of computers has gradually been expanded; however, it is difficult to efficiently operate products using only a keyboard and a mouse which currently serve as input devices. Therefore, the necessity for a device, which has a simple configuration and less malfunction and is configured for anyone to easily input information, has increased.

In addition, technologies for input devices have progressed toward techniques related to high reliability, durability, innovation, designing and processing, and the like, in addition to satisfying general functions. To this end, a touch panel including a touch sensor has been developed as input devices capable of inputting information such as texts and graphics.

The touch sensor is a device which is mounted on a display surface of a display such as an electronic organizer, a flat panel display device including a liquid crystal display (LCD) device, a plasma display panel (PDP), and an electroluminescence (El) element, and the like, and a cathode ray tube (CRT) to be used to allow a user to select desired information while viewing the display.

In addition, a type of the touch sensor may be classified into a resistive type, a capacitive type, an electro-magnetic type, a surface acoustic wave (SAW) type, and an infrared type. These various types of touch sensors have been adapted for electronic products in consideration of a signal amplification problem, a resolution difference, a difficulty of designing and processing technology, optical characteristics, electrical characteristics, mechanical characteristics, anti-environment characteristics, input characteristics, durability, and economic efficiency. Currently, the resistive type touch sensor and the capacitive type touch sensor have been used in a wide range of fields.

For example, the touch sensor may be configured to have a structure in which a transparent substrate adheres to a sensing unit by an adhesive and may be formed so that a bezel part formed along an edge of the transparent substrate covers a bus line of the sensing unit as described in the prior art KR2011-0053940.

Recently, in the IT devices, an exterior design becomes increasingly important and a size of a display screen tends to be large. To make the display screen large without increasing the size of the device appearance and implement a full color which is a color approaching an actual object, an effort to make an area or a thickness of the bezel part thinner has been progressed.

However, the area or thickness of the bezel part may vary depending on the color of the bezel part to be implemented. In particular, in the case of a color of a bright tone such as white which easily transmits light, the thickness of the bezel part cannot but be large to minimize the transmission of light, which went against the IT devices trend toward minimization and thinness. Therefore, there is a need to change a material and a structure to form a bezel which represents a bright color by reflecting light while making the thickness of the bezel part thin.

### PRIOR ART DOCUMENT

### Patent Document

(Patent Document 1) KR2011-0053940A

### SUMMARY OF THE INVENTION

Therefore, according to the present invention, a resin layer is disposed between a plurality of bezel layers in a bezel region of the touch sensor to form a difference in refractive index between the bezel layers and the resin layer, thereby confirming an increase in whiteness of the bezel region, and the present invention is completed based thereon.

The present invention has been made in an effort to provide a touch sensor capable of implementing a color of a bezel region as clear white by reducing a thickness of a bezel layer to implement a thin film type of bezel layer.

Further, the present invention has been made in an effort to provide a touch sensor capable of improving operation reliability of the touch sensor by reducing a step of a bezel layer.

According to a preferred embodiment of the present invention, there is provided a touch sensor, including: a window substrate; a first bezel layer formed at an edge portion of the window substrate and formed of at least one layer; and a resin layer disposed on the first bezel layer and the window substrate.

The touch sensor may further include: a second bezel layer disposed on the resin layer, at a position corresponding to the first bezel layer.

The resin layer may be made of a transparent material having a refractive index lower than that of the first bezel layer and the second bezel layer.

A refractive index of a visible light range of the first bezel layer and the second bezel layer may range from 1.3 to 3.

The first and second bezel layers may be made of the same material.

The first and second bezel layers may be made of different materials.

A thickness of the first bezel layer may range from 1 μm to 20 μm.

A thickness of the second bezel layer may range from 1 μm to 20 μm.

The first bezel layer and the second bezel layer may be made of any one selected from zinc oxide (ZnO), magnesium oxide (MgO), cesium oxide (CaCO₃), titanium oxide (TiO₂), aluminum (Al2O₃), silicon oxide (SiO₂), hafnium oxide (HfO₂), potassium titanate (KTaO₃), barium titanate (BaTiO₃), (Ba, Sr)TiO₃, and a combination thereof.

The resin layer may have a refractive index of 1 to 2 in a visible light range.

Transmittance in a visible light range of the resin layer may range from 50% or more to less than 99%.

A thickness of the resin layer may range from 0.1 μm to 10 μm.

The resin layer may be made of any one selected from an acrylic resin, a silicon-based resin, an epoxy resin, and a mixture thereof.

The silicon-based resin may be made of any one selected from SiO₂, SiNx, and a mixture thereof.

The resin layer or the second bezel layer may be further provided with a shielding layer.

The touch sensor may further include: an electrode pattern disposed on the resin layer and formed in an active area; and an electrode wiring disposed on the resin layer and formed in a bezel area.

The touch sensor may further include: an electrode pattern disposed on the resin layer and formed in an active area; and an electrode wiring formed between the resin layer and the second bezel layer.

The electrode wiring may be made of any one of copper (Cu), aluminum (Al), gold (Au), silver (Ag), titanium (Ti), palladium (Pd), chromium (Cr), nickel (Ni), ITO, an oxide-based transparent electrode, and a combination thereof.

The touch sensor may include: a stacked thickness of the first bezel layer, the second bezel layer, and the resin layer ranges from 2 to 50 μm.

According to another preferred embodiment of the present invention, there is provided a display device, including: a display panel; the touch sensor as described above formed on the display panel; and a housing receiving the touch sensor and the display panel.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of a display device including a touch sensor according to a preferred embodiment of the present invention;

FIG. 2 is a cross-sectional view of a touch sensor according to a first preferred embodiment of the present invention;

FIG. 3 is a cross-sectional view of a touch sensor according to a second preferred embodiment of the present invention;

FIG. 4 is a cross-sectional view illustrating a touch sensor including an electrode wiring according to another implementation of the present invention;

FIG. 5 is a partially enlarged cross-sectional view of a bezel region according to a preferred embodiment of the present invention; and

FIG. 6 is a graph illustrating results obtained by measuring a thickness and whiteness of a bezel layer depending on exemplary samples of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

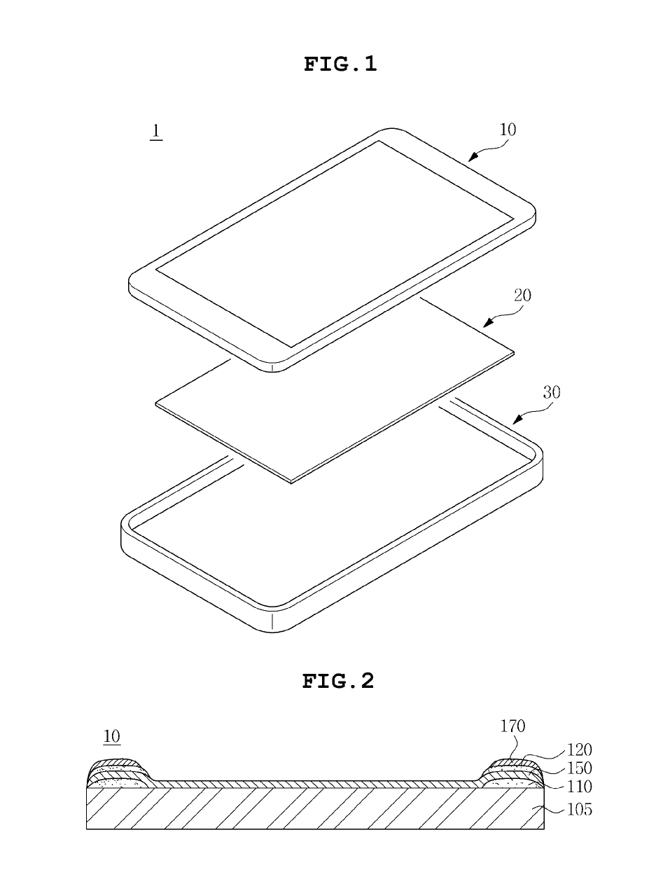

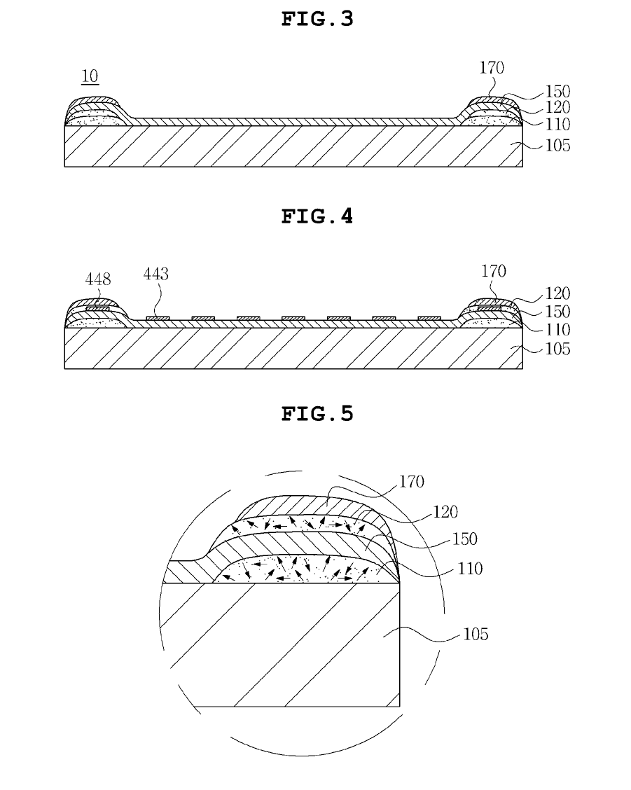

FIG. 1 is an exploded perspective view of a display device including a touch sensor according to a preferred embodiment of the present invention, FIG. 2 is a cross-sectional view of a touch sensor according to a first preferred embodiment of the present invention, and FIG. 3 is a cross-sectional view of a touch sensor according to a second preferred embodiment of the present invention.

Referring to FIG. 1, a display device 1 according to a preferred embodiment of the present invention includes a display panel 20, a housing 30 receiving the display panel 20, and a touch sensor 10 disposed on the display panel 20.

According to the preferred embodiment of the present invention, the display device 1 includes various types of information providing apparatuses, etc., such as television, navigation, a computer monitor, a game machine, and a mobile phone. Herein, for easy description, a mobile phone is illustrated by way of example.

The display panel 20 may display an image. The display panel 1 is not particularly limited, but an example of the display panel 1 may include various types of display panels, such as an organic light emitting display panel, a liquid crystal display panel, a plasma display panel, an electrophoretic display panel, and an electrowetting display panel.

The housing 30 may receive the display panel 20. FIG. 1 illustrates, by way of example, the housing configured of one member, but the housing 30 may be configured of a combination of at least two members. Further, the housing 30 may further receive a circuit board, and the like on which the display panel 20 as well as a plurality of active devices (not illustrated) and/or a plurality of passive devices (not illustrated) are mounted. Further, the housing 30 may further receive a power supply unit (not illustrated) such as a battery depending on a type of the display device 1.

The touch sensor 10 is disposed on the display panel 20 and is coupled with the housing 30 to form an outer surface of the display device 1 along with the housing 30. In this case, the display panel 20 may be coupled with the touch sensor 10.

The touch sensor 10 includes an active area in which an image generated on the display panel 20 is displayed and a bezel area adjacent to at least a portion of the active area, when viewing from the plane. Herein, the bezel area may be formed at an edge portion of the active area.

Referring to FIG. 2, the touch sensor 10 according to a first preferred embodiment of the present invention includes a window substrate 105, a first bezel layer 110 which is formed at an edge portion of the window substrate 105, a resin layer 150 which is disposed on the first bezel layer 110 and the window substrate 105, and a second bezel layer 120 which is disposed on the resin layer 150. Here, the resin layer 150 is made of a transparent material having a refractive index lower than that of the first bezel layer 110 and the second bezel layer 120.

The window substrate 105 is formed at an outermost side of the touch sensor 10 to be able to protect the touch sensor 10 from an external environment. The window substrate 105 may be made of a transparent material for visibility. Any material above a predetermined strength to protect the touch sensor 10, such as glass and tempered glass, may be used without being particularly limited.

The touch sensor 10 includes an active area A which displays a screen and recognizes a touch and a bezel area B which is formed at an edge portion of the active area A, in which the bezel area B may be formed to cover an electrode wiring, and the like.

The bezel area B may be provided with a plurality of bezel layers to improve visibility of the touch sensor 10 and characteristics in an appearance thereof by implementing clear colors in various types of devices including the touch sensor 10.

The bezel area B is provided with the first bezel layer 110 which is formed at the edge portion of the window substrate 105. The first bezel layer 110 may be formed of at least one layer. The resin layer 150 is disposed on a front surface of the window substrate 105 on which the first bezel layer 110 is formed. That is, the resin layer 150 is disposed in the bezel area B and the active area A. Further, the bezel area B in which the resin layer 150 is formed is further provided with the second bezel layer 120. The second bezel layer 120 is disposed on a position corresponding to the first bezel layer 110.

The first bezel layer 110 and the second bezel layer 120 may be made of a material having a refractive index of 1.3 to 3 in a visible light range. For example, the first bezel layer 110 and the second bezel layer 120 may be formed of a thin film and may be made of any one of titanium dioxide (TiO₂), aluminum oxide (Al₂O₃), silicon dioxide (SiO₂), hafnium oxide (HfO₂), and a combination thereof so as to have a refractive index of 1.3 to 3 in the visible light range. Further, the first bezel layer 110 may be made of any one of zinc oxide (ZnO), magnesium oxide (MgO), cesium oxide (ceria; Ce₂O₃), indium oxide (In₂O₃), indium tin oxide (ITO), barium titanate (BaTiO₃), potassium tantalate (KTaO₃), (Ba, Sr)TiO₃, and a combination thereof.

The first bezel layer 110 and the second bezel layer 120 may be made of titanium oxide (TiO₂) which may make light incident from outside of the window substrate 105 stay long and implementing a bright color. The first bezel layer 110 and the second bezel layer 120 may be made of the same material and may be made of different materials.

The first bezel layer 110 and the second bezel layer 120 may be formed by a screen printing method, a sputtering method, and the like. For example, when the first bezel layer 110 and the second bezel layer 120 are formed by the screen printing method, the bezel layer having a predetermined thickness may be formed by mixing titanium oxide having a particle size of 200 nm to 400 nm in a binder, and the like, disposing the screen on the window substrate, and pushing the paste which adhering the paste thereto by a squeeze. Here, in the case of for example, a particle of the titanium oxide (TiO₂), a particle having a size of about 300 nm is used and in the particle size, an intrinsic white color may be represented better.

The resin layer 150 may be interposed between the first bezel layer 110 and the second bezel layer 120. The resin layer 150 may be made of a material having a refractive index different from that of the first and second bezel layers 110 and 120. In other words, the resin layer 150 may be made of a transparent material having a refractive index lower than that of the first and second bezel layers 110 and 120. Here, the resin layer 150 may be formed so that the refractive index thereof becomes 1 to 2.

As such, the resin layer 150 scatters the light incident into the window substrate 105 in the first bezel layer 110 and the second bezel layer 120 due to the difference in refractive index, such that the color of the bezel region A may be more clearly implemented.

Further, the resin layer 150 may be made of a transparent material. The resin layer 150 may be made of a transparent material having transmittance which is 50% or more to less than 99% in the visible light range. The resin layer 150 may be made of a transparent resin such as acrylic resin, silicon-based resin, and epoxy resin so that the resin layer 150 has the refractive index of 1 to 2 while having the refractive index different from that of the first bezel layer 110 and the second bezel layer 120.

As the acrylic resin, at least one selected from acronitrile, alkyl acrylate, butyl acrylate, 2-ethylhexyl acrylate, t-butyl acrylate, n-octyl acrylate, acrylic acid, methacrylic acid, itaconic acid, 4-hydroxy-butyl acrylate, 2-hydroxy-ethyl(metha)acrylate, 2-hydroxy-ethylene glycol(metha)acrylate, and 2-hydroxy propylene glycol(metha)acrylate may be used.

As the epoxy resin, at least one selected from naphthalene-based epoxy resin, bisphenol A type epoxy resin, phenol novolac epoxy resin, cresol novolac epoxy resin, rubber modified epoxy resin, phosphate epoxy resin, and bisphenol F type epoxy resin may be used.

As the silicon-based resin, SiO₂, SiNx, and the like may be used.

As described above, the plurality of bezel layers 110 and 120 and the resin layer 150 are formed in the bezel area B to generate the difference in refractive index, thereby clearly implementing the desired color. Further, it is possible to easily implement the bright color, such as the white color.

For example, the bezel layers formed in the bezel area B have a difference depending on the material thereof to implement the clear colors, but the thicker bezel layers are generally required so as to implement the bright color, such as the white color.

The reason is that it is difficult for a user to see the colors of the bezel layers when light is completely transmitted to the bezel area B. Therefore, in order to implement the bezel layers having the bright color such as the white color, unlike the implementation of colors which differently absorb light, the bezel layer is formed in plural and therefore needs to be formed thicker. The plurality of bezel layers are a cause of an increase in the thickness of the touch sensor and a cause of the occurrence of an electric short of the electrode wirings.

However, the bezel layers 110 and 120 and the resin layer 150 according to the first preferred embodiment of the present invention may more clearly and effectively implement the color of the bezel area B by generating the difference in refractive index by interposing the resin layer 150 between the first bezel layer 110 and the second bezel layer 120.

Meanwhile, the resin layer 150 is disposed on the front surface of the window substrate 105 and the electrode wiring is disposed on the resin layer 150 to reduce a step between the electrode wiring and the bezel layer, thereby preventing the electric short between the electrode wirings and increasing the reliability of a product. The detailed description of the color implementation and the wiring reliability of the bezel area B will be described below.

Meanwhile, one surface of the bezel layers 110 and 120 and the resin layer 150 is further provided with a shielding layer 170, such that the color of the bezel area B may be more clearly and effectively implemented even when a thin film type of bezel layers 110 and 120 and resin layer 150 are formed.

The shielding layer 170 is disposed on the second bezel layer 120 which is formed in the bezel area B of the window substrate 105. The shielding layer 170 absorbs the light transmitted by scattering the light transmitted onto the window substrate 105 in the bezel layers 110 and 120 and the resin layer 150. It is possible to more easily implement the color of the bezel area B by the absorbed light. The shielding layer 170 may be appropriately formed to have absorptance which is 50% or more to less than 99% in the visible light range and may also be formed to have absorptance which is 70% or more to less than 99%. Here, the shielding layer 170 may be made of carbon black, chromium oxide (CrOx), and the like which may absorb light.

As described above, the resin layer 150 is interposed between the bezel layer 110 and the second bezel layer 120 to generate the difference in refractive index, thereby clearly implementing the bright color and making the touch sensor 10 thin.

Referring to FIG. 3, the touch sensor 10 according to a second preferred embodiment of the present invention may be sequentially provided with the first bezel layer 110, the second bezel layer 120, and the resin layer 150. Further, the shielding layer 170 may be further disposed on the resin layer 150. Herein, for easy description, it will be described with reference to FIG. 2.

According to the first preferred embodiment of the present invention, the resin layer 150 is interposed between the first bezel layer 110 and the second bezel layer 120 to generate the difference in refractive index, thereby clearly implementing the bright color and according to the second preferred embodiment of the present invention, the resin layer 150 is interposed between the shielding layer 170 and the first and second bezel layers 110 and 120 to generate the difference in refractive index, thereby improving the definition of the bright color.

That is, the thickness of the first and second bezel layers 110 and 120 in which the light may be scattered is formed to be thick, thereby improving the scattering efficiency and improving the definition of the bright color. Further, the probability that the light provided into the window substrate 105 may transmit the thick bezel layers 110 and 120 is reduced, and the light transmitted thereinto may be absorbed in the shielding layer 170. Therefore, the definition of the bright color represented in the bezel region B may be improved.

FIG. 4 is a cross-sectional view illustrating a touch sensor including an electrode wiring according to another implementation of the present invention. Here, for easy description while avoiding the repeated description, the touch sensor will be described with reference to FIGS. 1 to 3.

Referring to FIG. 4, in the touch sensor 10 according to another preferred embodiment of the present invention, the first bezel layer 110 is formed at the edge portion of the window substrate 105 and the resin layer 150 is formed at the front surface of the window substrate 105 on which the first bezel layer 110 is formed. Further, the second bezel layer 120 is disposed over the resin layer 150, at a position corresponding to the first bezel layer 110.

Describing the first preferred embodiment with reference to FIG. 4, the touch sensor 10 senses and recognizes a touch and includes an electrode pattern 443 formed in the active area. The electrode pattern 443 is disposed on the resin layer 150. Further, the touch sensor 10 includes an electrode wiring 448 which is connected to the electrode pattern 443 and is formed in the bezel area B. In this case, the electrode wiring 448 is interposed between the resin layer 150 and the second bezel layer 120.

The electrode wiring 448 generates a signal by a touch input unit to allow a control unit (not illustrated) to serve to recognize touched cooperates. In other words, the electrode pattern 443 formed in the active area A recognizes the touch and is connected to transfer positional information on the input touch to the electrode wiring 448 formed in the bezel area B. Further, the electrode wiring 448 and the electrode pattern 443 may be integrally formed.

The electrode wiring 448 passes through the bezel area B and the bezel layer according to the prior art may be formed of a plurality of layers to implement the clear colors of the bezel area. A surface of the window substrate is provided with a large step due to the plurality of bezel layers. Herein, the electrode pattern formed on the surface of the window substrate and the electrode wiring formed on the bezel layer cause the electric short in the area in which the electrode pattern is connected to the electrode wiring due to the formed step.

However, in the touch sensor 10 according to the preferred embodiment of the present invention, the resin layer 150 covers the window substrate 105 and the first bezel layer 110 to reduce the step which occurs in the area in which the electrode pattern 443 and the electrode wiring 448 disposed on the resin layer 150 is connected to each other.

Therefore, the touch sensor 10 according to the preferred embodiment of the present invention includes the plurality of bezel layers 110 and 120 to reduce the step while representing the clear and bright color, thereby preventing the electric short between the electrode pattern 443 and the electrode wiring 448 and implementing the more reliable touch sensor 10.

Meanwhile, in the touch sensor 10 according to the preferred embodiment of the present invention, as illustrated in FIG. 4, as the window integrated type, the electrode wiring 448 may be disposed on the resin layer 150. Herein, the window integrated type means the structure in which the electrode wiring 448 is directly disposed on the window substrate 105 or the structure in which the electrode pattern 443 is directly disposed on the window substrate 105 on which an additional function layer such as a separate adhesive layer is disposed and as illustrated in the drawings of the present invention, the structure of the touch sensor 10 according to the preferred embodiment of the present invention is not particularly limited.

Further, in addition to the structure in which the electrode pattern 443 is directly disposed on the window substrate 105, various structures of the touch sensor in which the electrode pattern is disposed on the separate base substrate and is coupled with the window substrate may be selected and applied. Herein, the base substrate may be made of a transparent material, but may be made of any material above a predetermined strength without being particularly limited. Therefore, the base substrate may be formed of for example, polytethylenetrephthalate (PET), polycarbonate (PC), polymethylmethacrylate (PMMA), polyethylenenaphthalate (PEN), polyethersulfone (PES), cyclic olefin polymer (COC), triacetylcellulose (TAC) film, and the like.

For example, the electrode patterns 443 may be disposed on the window substrate 105 so that the electrode patterns 443 of an X axis and a Y axis may be simultaneously formed on one layer, the electrode patterns 443 formed in one direction are disposed on the window substrate 105, and the electrode patterns 443 in the other direction intersecting the one direction are disposed on the separate base substrate so as to intersect therewith, thereby implementing the mutual capacitive type touch sensor 10.

Herein, the electrode pattern 443 and the electrode wiring 448 may be made of any one of copper (Cu), aluminum (Al), gold (Au), silver (Ag), titanium (Ti), palladium (Pd), chromium (Cr), nickel (Ni), ITO, oxide-based transparent electrode, and a combination thereof.

Herein, the electrode pattern 443 may be formed in a mesh pattern by using the above-mentioned material. Meanwhile, the electrode pattern 443 may also be formed using metal silver (Ag) formed by exposing/developing a silver salt emulsion layer, metal oxides such as an indium thin oxide (ITO), or the like, a conductive polymer such as PEDOT/PSS, or the like, having excellent flexibility and a simple coating process.

Meanwhile, the electrode pattern 443 and the electrode wiring 448 may be disposed on the resin layer 150, the second bezel layer 120 may be formed on the electrode wiring 448, and the shielding layer 170 may be further disposed on the second bezel layer 120.

Further, in the structure of the touch sensor 10 according to the second preferred embodiment of the present invention, when the shielding layer 170 is made of metal, an insulating layer made of an insulating material may be further disposed between the electrode wiring 448 and the shielding layer 170 to insulate between the electrode wiring 448 and the shielding layer 170.

FIG. 5 is a partially enlarged cross-sectional view of a bezel region according to an exemplary implementation of the present invention. Herein, in order to avoid the overlapping description, it will be described with reference to FIGS. 1 to 4.

Referring to FIG. 5, the bezel area B of the touch sensor 10 is sequentially provided with the first bezel layer 110, the resin layer 150, and the second bezel layer 120 which are disposed on the window substrate 105. Further, the touch sensor 10 may be provided with the shielding layer 170 which is disposed on the second bezel layer 120.

Herein, the bezel layers 110 and 120 of the bezel area B may be formed of a bezel having the bright color by using variables of the refractive index, the transmittance, the thickness in the visible light range. The shielding layer 170 is coupled on the first and second bezel layers 110 and 120 and the resin layer 150 to prevent light from directly transmitting the bezel layers 110 and 120, thereby implementing the bright color depending on the reflection of light.

In order to implement the bezel of the bright color, there is a need to increase the whiteness of the bezel area. As a method of increasing whiteness, a method of increasing reflectivity may be used. Making person's eyes feel a white color feels a white color when a brightness L* value among color coordinates (CIE) L*a*b* values becomes high and the a* and b* values approach 0. Here, the brightness L* value represents the reflectivity.

Further, as another method to increase the whiteness, when a larger amount of light incident into a medium is scattered, the higher whiteness may be implemented. As a method to increase the scattering, a medium having a large difference in refractive index is required. In this case, as a material having a low refractive index, the transparent material may be used.

As described above, in order to increase the whiteness, the first and second bezel layers 110 and 120 may be made of a material having a refractive index of 1.3 to 3. Herein, when the refractive index of the first and second bezel layers 110 and 120 is less than 1.3, the difference in refractive index from the resin layer 150 which is interposed between the first bezel layer 110 and the second bezel layer 120 is small and thus the scattering effect is reduced, such that it may be difficult to increase the whiteness and when the refractive index is 3 or more, the scattering effect is improved such that the whiteness may be increased but there may be a limitation of selecting the resin layer 150 made of a transparent material having a low refractive index.

Further, each of the first bezel layer 110 and the second bezel layer 120 may be formed to have a thickness of 1 μm to 20 μm. The first and second bezel layers 110 and 120 may be formed by the screen printing method, the sputtering method, and the like and when the first bezel layer 110 and the second bezel layer 120 are less than 1 μm, a space in which the incident light is scattered becomes small, such that the difference in refractive index may be reduced and when the first bezel layer 110 and the second bezel layer 120 exceeds 20 μm, the effect of increasing the whiteness and reducing the thickness disappears.

In order to generate the difference in refractive index, the resin layer 150 may use a medium having a larger difference in refractive index, comparing to the first bezel layer 110 and the second bezel layer 120, such that the scattering of the bezel area B may be increased.

In this case, the resin layer 150 may use the transparent resin having the lower refractive index, comparing to the first bezel layer 110 and the second bezel layer 120. The resin layer 150 may be made of for example, a transparent epoxy resin, acrylic resin, silicon-based resin, and the like and the refractive index thereof may be made of a material having a refractive index of 1 to 2.

Further, the thickness of the resin layer 150 may range from 0.1 μm to 10 μm. The resin layer 150 may be coated with an epoxy resin, an acrylic resin, a silicon-based resin, an the like by spin coating, and the like. Herein, the thickness of the coated resin layer 150 may be different from that of the active area A and the bezel area B on the window substrate 105. For example, in terms of the coating characteristics, when the thickness of the resin layer 150 formed in the active area A ranges from 5 μm to 6 μm, the resin layer 150 formed in the bezel area B may be formed to have a thickness of 3 μm to 4 μm.

The bezel area B which is formed of the first and second bezel layers 110 and 120 and the resin layer 150 may implement the clear whiteness while having a thin thickness due to the difference in refractive index depending on the following Equation.

$$n = \frac{c}{υ}$$

In this Equation, n represents the refractive index, c represents a velocity of light in the air, and v represents a velocity of light in a medium.

For example, titanium oxide (TiO₂) which is used in the first bezel layer 110 or the second bezel layer 120 is oxide and has the refractive index of about 2.5 to 2.9 and silicon oxide (SiO₂) used in the resin layer 150 represents the refractive index of about 1.4. That is, the scattering of light may be generated due to the difference in refractive index between the resin layer and the first and second bezel layers. Herein, a physical meaning of the refractive index represents a relative velocity of the incident light and the high refractive index may mean that the velocity of light is slow in the medium.

As described above, the higher the refractive index, the longer the time which light stays in the medium, and the reflection or the scattering is increased. Therefore, as the difference in refractive index between the bezel layers 110 and 120 and the resin layer 150 is increased, the whiteness of the bezel region B may be increased.

Hereinafter, the present invention will be described in more detail with reference to Examples and Comparative Examples, but the scope of the present invention is not limited to the following Example.

### Example 1

### Manufacturing of Paste

To form the bezel layer in the bezel area, 80 g of titanium oxide (Particles of TiO₂ are 200 nm to 400 nm), 19 g of thermosetting resin (ester-based polyol+isocyanate hardener), 30 g of isophorone which is a solvent, 0.8 g of dispersant (PB821), 0.3 g of other antifoaming agents (BYK057), and 0.3 g of leveling agent (BYK361n) were mixed and prepared.

Formation of First Bezel Layer

The glass substrate was used as the window substrate and the prepared titanium oxide paste was applied on the glass substrate once by the screen printing to form the first bezel layer having a thickness of 6 μm to 9 μm and dry it. Herein, the first bezel layer was formed at the edge area of the window substrate.

Formation of Resin Layer

The silicon oxide (SiO₂) was coated on the front surface of the window substrate, on which the first bezel layer is formed, by the spin coating and was formed to have a thickness of 2 μm to 6 μm.

Formation of Second Bezel Layer

The prepared titanium oxide paste was applied on the resin layer once by the screen printing to form the second bezel layer having a thickness of 6 μm to 9 μm and dry it. In this case, the second bezel layer was applied at a position corresponding to the first bezel layer.

Formation of Shielding Layer

After the second bezel layer is formed, the shielding layer was made of carbon black.

### Example 2

In Example 2, the titanium oxide paste was prepared like Example 1 and after the first bezel layer is formed, the second bezel layer was formed on the first bezel layer and the resin layer was formed on the second bezel layer. Others were formed like Example 1.

### Comparative Example 1

According to Comparative Example 1, the titanium oxide paste was prepared like the manufacturing of the titanium oxide paste according to Example 1 and the paste is applied at the edge surface of the window substrate once to form the bezel layer. Further, according to Comparative Example 1, the shielding layer was formed on the bezel layer without forming the transparent layer such as the resin layer which is formed like Example 1.

### Comparative Example 2

According to Comparative Example 2, the titanium oxide paste was prepared like the manufacturing of the titanium oxide paste according to Example 1 and the paste is applied at the edge surface of the window substrate two times to form the first and second bezel layers. Further, according to Comparative Example 2, the shielding layer was formed on the second bezel layer without forming the transparent layer such as the resin layer which is formed like Example 1.

### Comparative Example 3

According to Comparative Example 3, the titanium oxide paste was prepared like the manufacturing of the titanium oxide paste according to Example 1 and the paste is applied at the edge surface of the window substrate three times to form the first, the second and third bezel layers. Further, according to Comparative Example 3, the shielding layer was formed on the third bezel layer without forming the transparent layer such as the resin layer which is formed like Example 1.

Measuring Thickness of Bezel Layer and Whiteness

The touch sensor obtained according to Examples 1 and 2 and Comparative Examples 1 to 3 was cut to reveal the section of the bezel layer, thereby preparing a sample. Further, the thickness of the bezel layer was measured by measuring the thickness of the cut section using SEM. Further, the whiteness of the bezel layer was measured using UV/VIS spectrum.

The thickness of the bezel layer and the evaluation of the whiteness of the touch sensor which is manufactured with reference to Examples 1 and 2 and Comparative Examples 1 to 3 are represented in the following Table 1.

TABLE 1

| | The number of | Thickness | Whiteness |
|---|---|---|---|
| Sample | bezel layers | (μm) | (L*) |
| Comparative | 1 | 7.08 | 73.8 |
| Example 1 | | | |
| Comparative | 2 | 15.08 | 76.3 |
| Example 2 | | | |
| Comparative | 3 | 23.33 | 77.6 |
| Example 3 | | | |
| Example 1 | 3 | 16.72 | 78.1 |
| Example 2 | 3 | 17.50 | 83.0 |

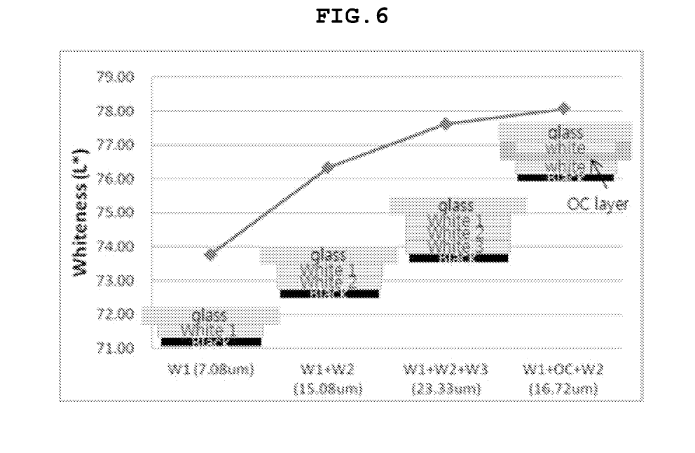

FIG. 6 is a graph illustrating results obtained by measuring a thickness and whiteness of a bezel layer depending on exemplary samples of the present invention.

Referring to FIG. 6 and Table 1, in Comparative Examples 1, 2, and 3, as the number of bezel layers is increased, it was measured that the whiteness is increased.

According to Comparative Example 1, the bezel layer was formed of one layer, such that the thickness thereof was measured as 7.08 μm and the whiteness was measured as 73.8. That is, the bezel layer is formed of one layer and thus may be thin; however, the bezel layer has the low whiteness, such that it is determined that the bezel layer is inappropriate to be used as the white bezel.

According to Comparative Example 2, the bezel layer was formed of two layers, such that the thickness thereof was measured as 15.08 μm and the whiteness was measured as 76.3. Therefore, the bezel layer is formed of two layers and thus comparing to Comparative Example 1, it is determined that as the thickness of the bezel layer is increased, the whiteness is increased or that the whiteness is inappropriate to be used as the bezel having the bright color.

According to Comparative Example 3, the bezel layer was formed of three layers, such that the thickness thereof was measured as 23.33 μm and the whiteness was measured as 77.6. Therefore, the bezel layer is formed of three layers and thus comparing to Comparative Examples 1 and 2, it is determined that as the thickness of the bezel layer is increased, the whiteness is increased and that the whiteness is also appropriate to be used as the bezel having the bright color. However, according to Comparative Example 3, the thickness is thick and the whiteness is increased; however the thickness is thick and thus the thinness is difficult to implement.

Therefore, it may be appreciated that in order to increase the whiteness, the bezel layer is formed of a plurality of layers and requires a predetermined thickness. For example, according to the prior art, in order to increase the whiteness, the plurality of bezel layers were used and the thickness thereof needs to range from 30 μm to 50 μm. As describe above, the thickness of the bezel layer may increase the whiteness, but the thinness is difficult to implement due to the thick thickness. Further, the electric short of the electrode wiring may occur due to the thick thickness of the bezel.

Meanwhile, according to Examples 1 and 2 of the present invention, it was measured that the whiteness is increased by appropriately combining the coating order of the first bezel layer, the second bezel layer, and the resin layer. According to Examples 1 and 2, it was determined that the whiteness is increased due to the difference in refractive index between the resin layer and the first and second bezel layers.

According to Example 1, three layers of the first bezel layer, the resin layer, and the second bezel layer are sequentially formed on the window substrate, such that the thickness thereof was measured as 16.72 μm and the whiteness was measured as 78.1. Therefore, although the bezel layer is formed of three layers, comparing to Comparative Example 3, it may be appreciated that the bezel layer is formed of a thin type. Further, although the thickness is formed in a thin type, comparing to Comparative Example 3, it was measured that the whiteness is increased. Therefore, according to Example 1, it is determined that the bezel layer is appropriate to be used as the bezel having the bright color.

According to Example 2, the first bezel layer, the second bezel layer, and the resin layer are formed of three layers which are sequentially formed on the window substrate, such that the thickness thereof was measured as 17.50 μm and the whiteness was measured as 83.00. Therefore, according to Example 2, the bezel layer is formed of three layers and thus it was measured that comparing to Comparative Example 3, although the thickness thereof is reduced, the whiteness is increased. Therefore, according to Example 2, it is determined that the bezel layer is appropriate to be used as the bezel having the bright color.

According to Examples 1 and 2, the first bezel layer, the second bezel layer, and the resin layer are configured of three layers, such that it is determined that the whiteness is increased due to the difference in refractive index between the first bezel layer and the second bezel layer and the resin layer. This makes the light incident from the outside stay in the first and second bezel layers for a long period of time due to the difference in refractive index between the first and second bezel layers and the resin layer, such that it is determined that the whiteness is increased.

In addition, the three layers of the first bezel layer, the second bezel layer, and the resin layer are configured, such that the overall thickness of the bezel may be reduced. Further, the bezel layer is thin by coating the resin layer and the electrode pattern and the electrode wiring are formed on the resin layer, such that the step of the bezel area passing through the electrode wiring may be reduced, thereby solving the problem in that the electrode wiring is electric-shorted and forming the more reliable bezel layer.

According to the preferred embodiments of the present invention, the plurality of bezel layers and the resin layer are stacked in the bezel region of the touch sensor together to form the difference in refractive index, thereby implementing the bright color even by the thinner bezel layer.

Further, the bezel layer is formed by the proper combination of the plurality of bezel layers and the resin layer to form the difference in refractive index, thereby more effectively increasing the whiteness which may be hardly implemented by the thin film type of bezel layer.

In addition, the touch sensor may be more stably operated by solving the electric short problem due to the step between the electrode pattern and the electrode wiring in the structure of the window integrated touch sensor in which the electrode wiring is disposed on the resin layer.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

1. A touch sensor, comprising:
a window substrate;
a first bezel layer formed at an edge portion of the window substrate and formed of at least one layer; and
a resin layer disposed on the first bezel layer and the window substrate.

2. The touch sensor as set forth in claim 1, further comprising:
a second bezel layer disposed on the resin layer, at a position corresponding to the first bezel layer.

3. The touch sensor as set forth in claim 2, wherein the resin layer is made of a transparent material having a refractive index lower than that of the first bezel layer and the second bezel layer.

4. The touch sensor as set forth in claim 2, wherein a refractive index of a visible light range of the first bezel layer and the second bezel layer ranges from 1.3 to 3.

5. The touch sensor as set forth in claim 2, wherein the first and second bezel layers are made of the same material.

6. The touch sensor as set forth in claim 2, wherein the first and second bezel layers are made of different materials.

7. The touch sensor as set forth in claim 1, wherein a thickness of the first bezel layer ranges from 1 μm to 20 μm.

8. The touch sensor as set forth in claim 2, wherein a thickness of the second bezel layer ranges from 1 μm to 20 μm.

9. The touch sensor as set forth in claim 2, wherein the first bezel layer and the second bezel layer are made of any one selected from zinc oxide (ZnO), magnesium oxide (MgO), cesium oxide (Ce2O3), titanium oxide (TiO2), aluminum (Al2O3), silicon oxide (SiO2), hafnium oxide (HfO2), potassium titanate (KTaO3), barium titanate (BaTiO3), (Ba, Sr)TiO3, and a combination thereof.

10. The touch sensor as set forth in claim 1, wherein the resin layer has a refractive index of 1 to 2 in a visible light range.

11. The touch sensor as set forth in claim 1, wherein transmittance in a visible light range of the resin layer ranges from 50% or more to less than 99%.

12. The touch sensor as set forth in claim 1, wherein a thickness of the resin layer ranges from 0.1 μm to 10 μm.

13. The touch sensor as set forth in claim 1, wherein the resin layer is made of any one selected from an acrylic resin, a silicon-based resin, an epoxy resin, and a mixture thereof.

14. The touch sensor as set forth in claim 13, wherein the silicon-based resin is made of any one selected from SiO2, SiNx, and a mixture thereof.

15. The touch sensor as set forth in claim 2, wherein the resin layer or the second bezel layer is further provided with a shielding layer.

16. The touch sensor as set forth in claim 1, further comprising:
an electrode pattern disposed on the resin layer and formed in an active area; and
an electrode wiring disposed on the resin layer and formed in a bezel area.

17. The touch sensor as set forth in claim 2, further comprising:
an electrode pattern disposed on the resin layer and formed in an active area; and
an electrode wiring formed between the resin layer and the second bezel layer.

18. The touch sensor as set forth in claim 16, wherein the electrode wiring is made of any one of copper (Cu), aluminum (Al), gold (Au), silver (Ag), titanium (Ti), palladium (Pd), chromium (Cr), nickel (Ni), ITO, an oxide-based transparent electrode, and a combination thereof.

19. The touch sensor as set forth in claim 2, wherein a stacked thickness of the first bezel layer, the second bezel layer, and the resin layer ranges from 2 to 50 μm.

20. A display device, comprising:
a display panel;
the touch sensor as set forth in claim 1 formed on the display panel; and
a housing receiving the touch sensor and the display panel.
